(19) United States
(12) Patent Application Publication
(10) Pub. No.: US 2002/0026592 A1
(43) Pub. Date: Feb. 28, 2002

(54) Method for automatic permission management in role-based access control systems

(75) Inventors: Serban I. Gavrila, Chevy Chase, MD (US); Virgil Dorin Gligor, Chevy Chase, MD (US)

Correspondence Address: William T. Ellis, FOLEY & LARDNER, Washington Harbour, 3000 K Street, N.W., Suite 500, Washington, DC, 20007-5109, US

(73) Assignee: VDG, INC.

(21) Appl. No.: 09/880,024

(22) Filed: Jun. 14, 2001

Related U.S. Application Data
(60) Provisional application No. 60/212,051, filed on Jun. 16, 2000.

(51) Int. Cl. H04L 12/22; G06F 11/30

(52) U.S. Cl. 713/201; 709/229

(57) ABSTRACT

A method for automatic permission management in centralized and distributed operating systems using role-based access control that supports selective and multiple instantiations of roles, multiple inheritance of permission and membership, and provides scalable and efficient distribution, review, and revocation of permissions and access authorization. The present invention provides, in a further aspect, automatic propagation of updates of role-permission hierarchies to the access control lists of all objects affected by such updates. The present invention provides, in yet a further aspect, per-role and per user review of permissions and requires neither redundant storage and additional administrative actions nor exhaustive searches of system resources. This invention makes use, in yet a further aspect, of both local and global groups for the instantiation of roles on multiple computer hosts, to implement nested groups and to enable the integration of extant host computers, which include local user accounts and groups defined on independent servers and workstations, within large distributed operating systems. In yet a further aspect, this invention provides the transition from an extant system state to an RBAC system state whereby permissions of users and groups to objects are managed centrally and automatically using roles, and removes the redundant user permissions to objects of a given state in the transition to the RBAC state.

### CROSS-REFERENCE TO RELATED APPLICATION(S)

This application claims the benefit of priority under 35 U.S.C. §119(e) of provisional application Ser. No. 60/212051 entitled “A Method For Automatic Permission Management In Role-Based Access Control Systems,” filed on Jun. 16, 2000, the disclosure of which is incorporated herein in its entirety.

### BACKGROUND OF THE INVENTION

In most of the installed centralized and distributed operating systems, permissions (also known in the art as access rights, or access privileges) determine whether a user may access data and programs of the system and its applications, as well as the manner in which the access can be performed (e.g., read, write, execute, append). The definition, management, and enforcement of permissions in a computer system are performed by a security subsystem of the operating system. Typical security subsystems define, store, and maintain permissions in access control lists (e.g., IBM RACF, Windows NT) or permission fields (e.g., UNIX) associated with corresponding objects or groups of objects. Also known in the art are security subsystems that associate permissions with the identifier of an object, the association being called a “capability” (e.g., in V. D. Gligor: “Review and Revocation of Access Privileges Distributed through Capabilities,” IEEE Transactions on Software Engineering, SE-5, Vol.6, Nov. 1979). Often, capabilities are stored and maintained as “capability lists” that are associated with users and groups.

Access authorization is performed by the security subsystem when a user (or, more generally, a user program) requests access to an object. The security subsystem looks up the user's permissions in the access control list or the permission field of the respective object. Alternatively, if capability lists are used, the security subsystem looks up the user's permissions in the capability for respective object located in the user's capability list. In either case, the security subsystem determines whether the user's permissions include those required for the requested access.

In most of the installed centralized and distributed computer systems, the management (i.e., the distribution, review, and revocation) of permissions is performed by system administrators at the granularity of the individual user, group, and object level. Although this granularity is adequate for most access-authorization policies enforced by security subsystems, it is far too low for management of permissions that must scale to large configurations of centralized and distributed systems (e.g., hundreds of applications, tens of thousands of users, and hundred of thousands of objects). Permission management at such low granularity often leads to increased administrative costs, administrator confusion, and to unnoticed errors, due to the sheer magnitude of the tasks being faced by system administrators and auditors.

RBAC (Role-Based Access Control) is intended to facilitate the management of permissions in large centralized and distributed operating systems, by distributing, reviewing, and revoking permissions for objects to roles rather than directly to individual users, and controlling users' permissions by granting or revoking them membership to appropriate roles. Furthermore, users can be reassigned from one role to another, without requiring any explicit permission distribution or revocation action by administrators at the object level (e.g., modifying access control lists, or permission bits of capabilities). Roles can be granted new permissions as new applications and objects become accessible, and permissions can be revoked from roles whenever necessary. Hence, a role consists of a group of users with the same responsibilities and tasks and, at the same time, of a set of permissions authorizing the operations necessary to perform user tasks.

Among the advantages of RBAC recognized by those skilled in the art are those of (1) simplifying the management of permissions, thus allowing fewer opportunities for administrative confusion, errors, and security breaches, (2) supporting more efficient administration, thus decreasing administrative costs, and (3) making possible the implementation of permission-management policies based on the user responsibilities within the enterprise.

It is understood by those skilled in the art that role-based access control systems may support two types of role hierarchies, one based on inheritance of role membership, and the other based on inheritance of role permissions. Role-membership inheritance is defined by membership inclusion; i.e., role r₂ “inherits” the membership of role r₁ if all the user members of role r₁ are also members of role r₂. For example, this a component that the role “employee” inherits the membership of role “manager,” since any manager is also an employee. In addition, the role manager has fewer members since not all employees are managers.

Role-permission inheritance is defined by permission inclusion; i.e., role r₁, “inherits” role r₂ if all the permissions of role r₂ are also permissions of role r₁. For example, this a component that the role “manager” inherits the role “employee,” since the role manager has all the permissions of the role employee. In addition, the role manager may include permissions that an ordinary employee does not have; e.g., reading and writing personnel files.

Each inheritance relation defines a directed acyclic graph on a set of roles, with the graph nodes representing the roles and graph arcs representing the inheritance relation between roles; i.e., there is an arc from role r₁ to role r₂ if and only if role r₂ inherits the members of r₁, or r₁ inherits the permissions of r₂. Although the two types of inheritance relationships are distinct and do not imply each other, in practice they need not be distinct. In fact, whenever the two types of directed acyclic graphs coincide, role administration (e.g., permission management) can be simplified. The representation of the permission inheritance among roles as a directed acyclic graph simplifies role definition, since new roles can be defined as extensions of multiple existing roles; i.e., multiple inheritance of permissions is supported, which helps decrease the number of distinct roles that have to be administered. The representation of membership inheritance as a directed acyclic graph enables the definition of inter-organization and interdepartmental groups of members with the same functional responsibilities; i.e., multiple inheritance of membership is supported. This helps support flexible organization structures in an enterprise, such as those needed for establishing dynamic coalitions or alliances. Few of the existing RBAC prototypes, and none of the RBAC systems available commercially, support multiple inheritance of either permissions or membership.

An explicit assumption of extant RBAC methods implemented in distributed operating systems is that the structure of the inheritance hierarchy of role permissions does not change very frequently, since this hierarchy and role definitions are intended to reflect enterprise structure, business, and applications, which typically change only infrequently (viz., V. D. Gligor: “Characteristics of Role-Based Access Control,” Proceedings of the First ACM Workshop on Role-Based Access Control, (C. E. Youman, R. S. Sandhu, and E. J. Coyne, eds.), Gaithersburg, Md., November 1995, pp. II-9-14; D. Ferraiolo et al.: “Role-Based Access Control: Features and Motivations,” Proceedings of the 11^{th} Annual Conference on Computer Security Applications, IEEE Computer Society Press, Dec. 1995, Los Alamos, Calif., pp.241-248; in A. Hummel, K. Deinhart, S. Lorenz, and V. D. Gligor: “Role-Based Security Administration,” in Security in Information Systems, (K. Bauknecht, D. Karagiannis, and S. Teufel (eds.)), ETH Press, Zurich, 1996, ISBN 3 7281 2339 0.) Changes of role-permission hierarchies include (1) changes of role-permission inheritance, (2) creation and registration of new objects and assignment to roles, or object deletion and de-registration, and (3) distribution and revocation of permissions to roles. As a consequence of this assumption, existing RBAC systems and methods do not provide automated a component to propagate dynamic updates of permission hierarchies to the access control lists of all objects affected by such updates. Lack of automatic propagation of permission hierarchy updates, prevents existing RBAC systems from updating access control policies and role structures in an enterprise efficiently, without extensive administrative intervention, and flexibly, to reflect dynamic changes in enterprise organization and business characteristics; e.g., do not allow the definition and management of dynamic, limited-lifetime, coalitions, or alliances, among users and roles of different organizations. Lack of automatic propagation of permission hierarchy updates, also prevents existing RBAC systems to build the role hierarchy of a system incrementally on the top of existing operating systems. This limits the possibility of transition between extant operating systems access control based on user accounts, groups, and access control lists, to RBAC.

RBAC methods and systems require per-role review of permissions; i.e., the review of permissions assigned to a specific role or set of roles (and users). Per-role review is necessary to (1) determine whether two or more roles (or users) share permissions to objects (e.g., as required by operational separation-of-duty policies, in V. D. Gligor, S. I. Gavrila and D. Ferraiolo: “On the Formal Definition of Separation-of-Duty Policies and their Composition,” IEEE Symposium on Security and Privacy, Oakland, Calif., May 1998, pp. 172-185); (2) implement automatic permission distribution and revocation (e.g., as required when new permission-inheritance relations are established or removed, and when new roles are created and removed); and (3) support the auditing of role and user permissions. A disadvantage of RBAC methods implemented in existing distributed operating systems is that per-role review is either not supported or, if it is supported, it is implemented either by maintenance of redundant permission information (e.g., both capability and access control lists) or by exhaustive searches of all the object space to find all the access control lists that might include a given role's permissions. Redundancy requires synchronization between copies of the same permissions (e.g., capability and access control list contents), and exhaustive searches are impractical since they take a prohibitively long amount of time. In either case, the result is increased complexity of permission management, which is error-prone, cumbersome, and costly in large distributed systems with many roles, and decreased performance.

The only RBAC method for large distributed operating systems known in the state of the art that support per-role review is described in U.S. Pat. No. 5,911,143, dated Jun. 8, 1999, entitled “Method and System for Advanced Role-Based Access Control in Distributed and Centralized computer Systems,” co-authored by K. Deinhart, V. D. Gligor, C. Lingenfelder, and S. Lorenz, and implemented, in part, by Tivoli Systems. This method and system require redundant storage and management of permissions; i.e., both capability and access control lists to support per-role review of privileges.

A further disadvantage of all extant RBAC systems and methods known in the state of the art is that, whenever they represent roles as groups of the underlying distributed operating systems, they fail to support both local and global groups. Such support is required whenever extant host computers, which include local user accounts and groups defined on independent servers and workstations, are integrated within distributed operating systems and applications. These host computers use extant applications that rely on access control based on local user accounts and group structures and would fail to run if these local structures would be eliminated during extant host-computer integration within distributed systems. The practical consequence of this disadvantage is that either extant applications would fail to run in the distributed operating systems or a costly application conversion would become necessary, which would sometimes be impractical due to unavailability of application source code.

Concerning the automatic management of permissions in RBAC systems and methods known in the prior art, it has been recognized by the present inventors (and is an aspect of the invention) that it is disadvantageous that either they lack a component for selective and multiple instantiations of roles, or, when they incorporate such a component, they do not support multiple inheritance either in the membership or in the permission hierarchy. Lack of selective and multiple instantiations of roles or lack of multiple inheritance, imposes serious limitations in managing permissions in large distributed systems, such as (1) inability to scale the distributed system to large user, role, object, and application configurations; and (2) substantially increased manual administrative operations, which is error-prone, cumbersome, and costly in large distributed systems with many roles.

It has been further recognized by the present inventors (and is an aspect of the invention) that it is disadvantageous that existing RBAC systems and methods do not automatically propagate updates of role-permission hierarchies to the access control lists of all objects affected by such updates. Lack of automatic propagation of role-permission hierarchy updates, prevents existing systems from (1) changing access control policies and role structures in an enterprise efficiently, without extensive administrative intervention, and flexibly, to reflect dynamic changes in enterprise structure and business characteristics; and (2) building role hierarchies incrementally, thereby limiting the possibility of incremental transition between extant operating systems access control based on user accounts, groups and access control lists to RBAC.

It has been further recognized by the present inventors (and is an aspect of the invention) that it is disadvantageous that existing RBAC systems and methods either lack a component to implement the review of users' or roles' permissions to objects or, when such a component is available, they require redundant storage for managing permissions and additional administrative actions to synchronize the content of permissions copies. As a result of this disadvantage, either large classes of security policies cannot be implemented or their implementation requires increased complexity and inefficiency in managing permissions.

Concerning the representation of roles or role instances with groups in RBAC systems and methods known from prior art, it has been further recognized by the present inventors (and is an aspect of the invention) that it is disadvantageous that existing RBAC systems and methods fail to support both local and global groups. Such support is required whenever extant host computers, which include local user accounts and groups defined on independent servers and workstations, are integrated within distributed operating systems and applications. As a result, either extant applications fail to run in the distributed operating systems or a costly application conversion becomes necessary, which sometimes is impractical due to unavailability of application source code.

Concerning the transition from an extant method of permission management at the granularity of individual user, group and object level to automatic permission management using roles in RBAC, it has been further recognized by the present inventors (and is an aspect of the invention) that it is disadvantageous that existing RBAC systems and methods either fail to provide any component to perform such transition or, when such a component is provided, they fail to derive both membership and permission inheritance relations of a system state and use them to remove redundant user permissions to objects. As a result, access authorization is less efficient and the RBAC system is less secure than anticipated.

### SUMMARY OF THE INVENTION

Briefly, the present invention comprises in one aspect, a method for the automatic distribution, review and revocation of user and group permissions to objects through management of role permissions to abstract objects, in a computing environment comprises a role-based access control system that includes a directed acyclic graph representing role-membership inheritance relationships and a directed acyclic graph representing role-permission inheritance relationships, said method comprising association of each role with the set of abstract objects accessible to the said role, said association requiring neither redundant storage and maintenance of permissions nor exhaustive system searches.

In a further aspect, the invention comprises defining and managing the abstract permissions of a role on abstract objects; finding, retrieving, and displaying abstract permissions of a role on abstract objects; adding an abstract object to the set of abstract objects associated with a role whenever the abstract object becomes accessible to that role; deleting an abstract object from the set of abstract objects associated with a role whenever the abstract object becomes inaccessible to that role.

In yet a further aspect, defining and managing the abstract permissions further comprise creating, finding, retrieving, displaying, and deleting instances of a role on a host computer or set of host computers, using group nesting and a directed acyclic graph of role-membership inheritance; creating finding, retrieving, displaying, and deleting object instances of abstract objects on a host computer or set of host computers; registering objects as instances of abstract objects on a host computer or set of host computers; deriving permissions of a role instance on object instances from the abstract permissions of the role on abstract objects; registering permissions on objects as instances of abstract permissions on abstract objects on a host computer or set of host computers; and finding, retrieving, and displaying the permissions derived from abstract permissions defined on abstract objects.

In a further aspect, creating, finding, retrieving, displaying, and deleting role instances of a role on a host computer or set of host computers comprises creating an instance of a RBAC user on a set of host computers, the user instance being called global with respect to the set of host computers; creating an instance of a RBAC user on a host computer, the user instance being called local with respect to the host computer, unless the host computer is used to control a set of host computers, in which case the instance is called global with respect to the set of host computers; creating a role instance on a set of host computers, the role instance being called global with respect to the set of host computers; creating a role instance on a host computer, the role instance being called local with respect to the host computer, unless the host computer is used to control a set of host computers, in which case one can select whether the instance will be local with respect to the host computer, or global with respect to the set of host computers; including a local user instance in a local role instance, if the user is assigned to the role, and both instances were derived on the same host computer; including a global user instance in a local role instance, if the user is assigned to the role, and the local role instance was derived on a host computer included in the set of host computers used to derive the global user instance; including the global user instance in a global role instance, if the user is assigned to the role, and both instances were derived on the same set of host computers; including the members of a local instance of a first role in a local instance of a second role, if the second role inherits the membership of the first role, and both instances were derived on the same host computer; including the global instance of a first role as a member of a local instance of a second role, if the second role inherits the membership of the first role, and the local instance was derived on a host computer included in the set of host computers used to derive the global instance; and including the members of a global instance of a first role in a global instance of a second role, if the second role inherits the membership of the first role, and both instances were derived on the same set of host computers.

In a further aspect, creating, finding, retrieving, displaying, and deleting role instances of a role on a host computer or set of host computers comprise computing, displaying, reviewing, and listing the permissions of any role to abstract objects; computing, displaying, reviewing, and listing the permissions of any role to object instances; computing, displaying, reviewing, and listing the permissions of any role instance to object instances.

In a yet further aspect, computing, displaying, reviewing, and listing the permissions of any role comprise determining whether two or more roles share permissions on any abstract objects; determining whether two or more roles share permissions on any object instances; determining whether two or more role instances share permissions on any object instances; implementing and testing any policy that is satisfied by the determination of whether two or more roles share permissions to abstract objects; implementing and testing any policy that is satisfied by the determination of whether two or more roles share permissions to object instances; implementing and testing any policy that is satisfied by the determination of whether two or more role instances share permissions to object instances.

In yet a further aspect, policy implementing and testing comprise implementing and testing generalized separation-of-duty policies; and implementing and testing operational separation-of-duty policies.

In a further aspect, creating, finding, retrieving, displaying, and deleting role instances of a role on a host computer or set of host computers comprise automatic distribution of permissions on object instances to role instances whenever new permission-inheritance relations are established among roles; automatic distribution of permissions on object instances to role instances whenever new roles are added to the directed acyclic graph; automatic distribution of permissions on object instances to role instances whenever a new role instance is created for a role on a host computer or set of host computers; automatic distribution of permissions on object instances to role instances whenever a new object instance is created for an abstract object on a host computer or set of host computers; and automatic distribution of permissions on object instances to role instances whenever a new permission is granted to a role.

In a further aspect, creating, finding, retrieving, displaying, and deleting role instances of a role on a host computer or set of host computers comprise automatic revocation and recalculation of permissions on object instances for role instances whenever permission-inheritance relations among roles are removed; automatic revocation and recalculation of permissions on object instances for role instances whenever roles are removed; automatic revocation and recalculation of permissions on object instances for roles instances whenever an abstract object is removed; automatic revocation and recalculation of permissions on object instances for role instances whenever a permission is revoked from a role.

In a further aspect, creating, finding, retrieving, displaying, and deleting role instances of a role on a host computer or set of host computers comprise scaleable, automatic, distribution, revocation, and recalculation of permissions of role instances to object instances that support efficient access authorization.

In a further aspect, scaleable, automatic, distribution, revocation, and recalculation of permissions of role instances to object instances comprise adding a new permission-inheritance arc to the directed acyclic graph between a first role called inheritor role and a second role called the inherited role whereby the inheritor and all its ascendant roles inherit all the permissions of the inherited role and its descendant roles in the directed acyclic graph; automatically selecting the roles that do not have instances on a host computer or set of host computers from the set comprises the inherited role and its descendants in the directed acyclic graph; automatically computing a set of permissions by mapping the abstract permissions of the selected roles on all abstract objects that do have instances on the host computer or set of host computers; automatically granting the computed permissions to the instance of each first encountered role instantiated on the host computer or set of host computers by traversing the directed acyclic graph in the direction opposite to that of the inheritance arcs on any path starting from the inheritor role.

In yet a further aspect, adding a new permission-inheritance arc to the directed acyclic graph between a first role called inheritor role and a second role called the inherited role comprise removing a permission-inheritance arc from the directed acyclic graph between a first role called inheritor role and a second role called the inherited role; and automatically recalculating permissions and granting the permissions to the instance of each first encountered role instantiated on a host computer or set of host computers, by traversing the directed acyclic graph in the direction opposite to that of the inheritance arcs on any path starting from the inheritor role.

In yet a further aspect, adding a new permission-inheritance arc to the directed acyclic graph between a first role called inheritor role and a second role called the inherited role comprise revoking an abstract permission to an abstract object from a role where the abstract object has an instance on a host computer or set of host computers; automatically updating the association between the role and the set of accessible abstract objects; automatically recalculating and granting the permissions to the instance of each first encountered role instantiated on a host computer or set of host computers, by traversing the directed acyclic graph in the direction opposite to that of the inheritance arcs on any path starting from that role.

In yet a further aspect, adding a new permission-inheritance arc to the directed acyclic graph between a first role called inheritor role and a second role called the inherited role comprise deleting a role from the directed acyclic graph, further comprising selecting a role for deletion from the directed acyclic graph; automatically removing the role from the access control lists of all abstract objects accessible to that role; automatically deleting the association between the role and all abstract objects accessible to that role; automatically recalculating permissions and granting permissions to the instance of each first encountered role instantiated on a host computer or set of host computers, by traversing the directed acyclic graph in the direction opposite to that of the inheritance arcs on any path starting from the any direct ascendant of the selected; automatically deleting all instances of the selected; and automatically deleting the selected role from the directed acyclic graph.

In a further aspect, scaleable, automatic, distribution, revocation, and recalculation of permissions of role instances to object instances comprise creating an instance of a role on a host computer or set of host computers; automatically selecting the roles that did not have instances on that host computer or set of host computers prior to the creation of the role instance, wherein the selection is performed from that role and its descendant roles in the directed acyclic graph; automatically computing a set of permissions by mapping the abstract permissions of the selected roles on all abstract objects that do have instances on the host computer or set of host computers; and automatically granting the computed permissions to the role instance just created.

In a further aspect, scaleable, automatic, distribution, revocation, and recalculation of permissions of role instances to object instances comprise

creating an instance of a user on a host computer or set of host computers; automatically selecting the roles that did not have instances on said host computer or set of host computers prior to the creation of said user instance, wherein the selection is performed from said user and its descendant roles in the directed acyclic graph; automatically computing a set of permissions by mapping the abstract permissions of the selected roles on all abstract objects that do have instances on the host computer or set of host computers; and automatically granting the computed permissions to the user instance just created.

In a further aspect, scaleable, automatic, distribution, revocation, and recalculation of permissions of role instances to object instances comprise granting a role an abstract permission to an abstract object that has an instance on a host computer or set of host computers and automatically causing the role's ascendant roles and users to inherit the abstract permission; automatically updating the association between that role and the set of accessible abstract objects; automatically mapping the abstract permission of that role on that abstract object to a set of permissions for the object instance; and automatically granting the set of permissions to the instance of each first encountered role instantiated on the host computer or set of host computers by traversing the directed acyclic graph in the direction opposite to that of the inheritance arcs on any path starting from the role being granted the abstract permission.

In a further aspect, scaleable, automatic, distribution, revocation, and recalculation of permissions of role instances to object instances comprise instantiating an abstract object on a host computer or set of host computers; automatically reading the access control list of the abstract object and computing the set of roles that have abstract permissions to the abstract object; for each role in the set, automatically mapping the abstract permissions of the role on the abstract object to a set of permissions for the object instance; and automatically granting the set of permissions to the instance of each first encountered role instantiated on the host computer or set of host computers by traversing the directed acyclic graph in the direction opposite to that of the inheritance arcs on any path starting from that role.

In a further aspect, scaleable, automatic, distribution, revocation, and recalculation of permissions of role instances to object instances comprise deleting an abstract object, further comprising automatically finding and deleting all instances of the abstract object and their access control lists; automatically reading the access control list of the abstract object arid, for each role found in the access control list, removing the abstract object from the association between the role and its set of accessible abstract objects; and automatically deleting the abstract object and its access control list.

In a further aspect, scaleable, automatic, distribution, revocation, and recalculation of permissions of role instances to object instances comprise directed acyclic graph of roles representing both membership and permission inheritance, abstract objects, and abstract permissions, from the user account, group, and access control list and permission structures of extant operating systems; and performing the incremental transition from an extant permission management system to automatic permission management in RBAC.

In a further aspect, deriving a directed acyclic graph of roles representing both membership and permission inheritance comprise deriving membership-inheritance and permission-inheritance relationships among the existing user accounts and groups; creating roles and assigning selected user accounts and groups to said roles; deriving membership-inheritance and permission-inheritance relationships among said roles and obtaining a directed acyclic graph for each type of inheritance relationship; and transforming the said directed acyclic graphs into a single directed acyclic graph of membership inheritance that preserves the permission of the user accounts defined by permission inheritance.

### BRIEF DESCRIPTION OF THE DRAWINGS

FIG. 1 is a schematic diagram of the instantiation of roles, abstract objects, and abstract permissions on a computer host, h, or set of host computers, d(h). The left half of the diagram illustrates the abstract view of RBAC (Role-Based Access Control) in which a role r has an abstract permission ap on an abstract object ao. The right half of the diagram illustrates an instance of the RBAC view on h, or on d(h), in which (1) role r and object ao have instances on h or d(h), and (2) the role instance gr gets permission p on the object instance o, where p is a mapping of the abstract permission ap to actual permissions on object instance o. The mapping from ap top is defined by the type of the abstract object ao.

FIG. 2 is a schematic diagram of the instantiation of roles, abstract objects, and abstract permissions on a computer host, h, or set of host computers, d(h), when some roles with abstract permissions on abstract objects are left without instances. Role r₂ has the abstract permission ap on abstract object ao; abstract object ao has an instance o on h, or d(h); role r₂ has no instance on h or d(h). Role r₁ inherits the permissions of role r₂ in the role graph, and has a role instance gr₁ on h, or d(h). The method assigns role instance gr₁ permission p (the permission instance of ap) on object instance o.

FIG. 3 gives an overview of the method for permission management in RBAC systems contained in this invention. The left half of the figure shows a portion of the directed acyclic graph of roles, where some roles and users have been granted abstract permissions on some abstract objects. The right half of the figure shows the relationships between instances of users, roles, permissions, and objects built by the inventive method. rᵢ, i=1, . . . ,5, denote roles, uᵢ, i=1, . . . ,3, denote users, the thick arrows denote role graph arcs, aoᵢ, i=1, . . . 4, denote the abstract objects, the thin arrows labeled apᵢ, i=1, . . . ,4, denote abstract permissions. uaᵢ, i1, . . . ,3, denote user accounts (instances of users uᵢ), grᵢ, i=3, . . . ,5, denote groups (instances of rᵢ), oᵢ denote objects (instances of aoᵢ), and the thin arrows labeled pᵢ, i=1, . . . ,4, denote permissions.

FIG. 3 shows the case when the role view defined by role r₃ and abstract objects ao₁, ao₂, ao₃, ao₄, have been instantiated on h, or d(h). Both permission inheritance and membership inheritance are used to increase the efficiency of permission distribution and access authorization. Role instance gr₃ is granted permission pi on object instance o₁ because role r₃ inherits the permissions of role r₁. Role instance gr₃ is granted permissions p₂ on object instance o₂ because role r₃ has abstract permission ap₂ as its own permission on abstract object ao₂. However, permission p₃ is not propagated to the instances of role r₃'s ascendants (i.e., to role instances gr₄, gr₅, and users ua₁, ua₂, ua₃), because users ua₁, ua₂, ua₃ all are members of role instance gr₃ (by membership inheritance), and thus have permission p₃.

FIG. 4 is a schematic diagram of automatic permission distribution when a new role permission inheritance relationship is established between roles r and s. Role q is one of the first ascendants of role r instantiated on a host computer h, or set of host computers d(h), encountered along a path in the role graph starting from r and going in the opposite direction of the arcs. Role t is either role s or any of its descendant roles, such that role t has an abstract permission ap on an abstract object ao that has an instance on h, or d(h). The method establishes the inheritance relationship r→s and grants the instance of role q the permission p to object o, where o is an instance of abstract object ao, and p is an instance of the abstract permissions ap. The roles beneath q in the role graph do not have instances on h, or d(h). The roles above role q in the graph have instances on h, or d(h), but the members of their instances are also members of the q's instance, and hence, they automatically receive all permissions of q's instance.

FIG. 5 is a schematic diagram of automatic permission distribution when the entire view defined by a role r is instantiated on a host computer h, or set of host computers, d(h). Role r and its view had no instance on h, or d(h), prior to this instantiation operation. Role s is any descendant of role r that has an abstract permission ap on an abstract object ao, and ao has an instance on h. Note: role s has no instance on h, or d(h); otherwise, role r would have already had an instance on h, or d(h).The new instance of role r is granted the permissions on object o, where o is the instance of abstract object ao on h, or d(h), and permission p is the instance of ap. In addition, role q represents r or one of its ascendants, which becomes instantiated. If role q has an abstract permission ap′ on an abstract object ao′ that has an instance on h, then new instance of role q is granted permission p′ on object o′, where o′ is the instance of ao′ and p′ is the instance of ap′.

FIG. 6 is a schematic diagram of automatic permission distribution when an abstract object ao is instantiated on a host computer h. Role s is one of the roles that have an abstract permission ap on ao. If role s has an instance gs on h, or d(h), then the method grants role instance gs the permission p on o, where p is the instance of ap, and o is the new instance of the abstract object ao. If role s has no instance on h, or d(h), then for any role r that is the principal of any view instantiated on h, or d(h), the method tests whether role r inherits the permissions of role s. If role r inherits the permissions of role s, the method grants permission p on o to gr, which is the instance of role r on h or d(h).

FIG. 7 is a schematic diagram of automatic permission distribution when a role r is granted an abstract permission ap to an abstract object ao. For any host computer h on which abstract object ao has an instance o, starting from role r on any path of the graph in the opposite direction of the arcs, the method finds the first ascendant of r instantiated on h or d(h), denoted by role q, and grants gq, the instance of role q, the permission p to object o, where p is the instance of the abstract permission ap.

### DETAILED DESCRIPTION OF THE PREFERRED EMBODIMENTS

Definitions

This section describes a preferred method and embodiment of a system for automatic permission management in Role-Based Access Control (RBAC) systems. The preferred method and embodiment use definitions known in the prior art, in particular in D. Ferraiolo et al.: “Role-Based Access Control: Features and Motivations”, Proceedings of the 11^{th} Annual Conference on Computer Security Applications, IEEE Computer Society Press, Dec. 1995, Los Alamos, Calif., pp.241-248, and in U.S. patent application Ser. No. 09/371,841, dated Aug. 11, 1999, entitled “A Method for Managing Role-based Access Control Policies on Top of User Account and Group Mechanisms,” co-authored by D. F. Ferraiolo and S. I. Gavrila. This section reviews these definitions.

Role Hierarchies Based on Inheritance Types

The preferred method uses two types of role hierarchies, one based on the inheritance of role membership, and the other based on the inheritance of role permissions. The “membership-inheritance” relation can be defined as follows:

r₁ membership-inherits r₂ [symbol] all user members of r₂ are members of r₁.

The “permission-inheritance” relation can be defined as follows:

r₁ permission-inherits r₂ [symbol] all permissions of r₂ are permissions of r₁.

Inheritance Notation

The preferred method denotes the permission-inheritance relation by the symbol “→”. Thus, r₁→r₂ means that r₁ inherits r₂'s permissions. The preferred method denotes the inverse of the membership-inheritance relation by the symbol [symbol] i.e. r₁ [symbol] r₂ means that r₂ inherits r₁'s members, or that r₁'s members are included in r₂.

As usual, we denote by →* and →⁺ the reflexive- and transitive-closure of the → relation. Similarly for the [symbol] relation.

We require that no role inherit itself, either directly or indirectly, i.e., no role r exists such that r→⁺r (or r [symbol] ⁺r).

Users as Roles, and Assignment as Inheritance

The preferred method considers an RBAC user as a role with a unique member: the user itself. For the purpose of including users in the role graph, the preferred method considers the assignment of a user u to a role r as a particular case of membership-inheritance: u [symbol] r (which can be read as “u is included in r”). If we decide to define a permission-inheritance relationship between u and r, then we will write u→r, i.e., u inherits r's permissions.

Role Hierarchies as Graphs

Each inheritance relation defines a directed acyclic graph on the role set (which includes the users as a subset). The graph nodes represent the roles, and the graph arcs represent the permission-inheritance relation, or the inverse of the membership inheritance relation; i.e., there is an arc from r₁ to r₂ if and only if r₁→r₂, or r₁ [symbol] r₂.

Ascendants and Descendants of a Role Graph Node

In general, we draw the role graph with the arcs pointing downward, which justifies the following definition. If r is a node of a role graph, we call an ascendant of r a node p such that p→⁺r (for the graph of permission-inheritance), or p [symbol] ⁺r (for the graph of membership inheritance). If p→r or p [symbol] r, we call p a direct descendant of r. Similarly, we call a descendant of r a node p such that r→⁺p, or r [symbol] ^{+p.}

Views of the Role Graph and Principals

A view of the role graph, defined by a role r, is the sub-graph whose nodes are all roles p such that p→*r, i.e., p is either r or an ascendant of r, and whose arcs are defined by the restriction of → to this subset of nodes. Similarly for the [symbol] relation. A view defined by roles r₁, . . . ,rₙ is the union of the views defined by r₁ . . . , rₙ.

If the roles r₁, . . . , rₙ that define the view have the property that none of them inherits another, then we call each of them principals of the view. It is easy to see that, given a view, we always can find a set of principals defining the view.

Instantiation of a View

Instantiating a role view on a host operating system (or on any other system which provides a group/user security mechanism) means automatically (1) creating groups and user accounts that correspond to the role and user nodes of the view and either (2a) populating the groups with user accounts as the membership-inheritance relationships of the view prescribe, or (2b) setting distributing permissions to groups and user accounts as the permission-inheritance relationships of the view prescribe, or (2c) combining the previous actions if the view or views we instantiate are based on both permission- and membership-inheritance. The groups and user accounts created on that host are called instances of the roles and users included in the instantiated view.

We know only one system that automatically instantiate views of the role graph, and it uses approach (2a). The instantiating method used by that system satisfies the following three instantiation rules:

Rule 1. If role r₂ has an instance on a host system h, and r₁ [symbol] r₂, then r₁ must also have an instance on h or d(h). Similarly for r₁→r₂.

In other words, when the RBAC system instantiates a role r, it must instantiate any ascendant of r; i.e., it actually instantiates the entire view defined by role r.

It is evident to those skilled in the art that other embodiments may be chosen whereby the instantiation of a role view may refer to a subset of the roles of that view.

Rule 2. If the role graph is based on membership-inheritance, u is a user assigned to role r, and r has an instance (group) on host system h, then u's instance (a user account) must be a member of r's instance.

Rule 3. If the role graph is based on membership-inheritance, and r₁, r₂ are two roles such that r₁ [symbol] r₂, and r₂ has an instance (a group) on host system h, then all members of rl's instance (a group) must be included in r₂'s instance on h.

Method

The present invention provides, in one aspect, automatic distribution and revocation of permissions in RBAC systems that support selective and multiple instantiations of roles. The invention provides, in a further aspect, multiple inheritance of both membership and permissions. The method combines membership and permission inheritance to obtain scalable and efficient distribution/revocation of permissions and access authorization. This means that, despite large sets of roles and role instances, access control lists will include fewer entries since groups denoting role instances can contain large numbers of users obtained via membership inheritance. However, groups will have a compact representation by using group nesting. Furthermore, efficient and scalable role definition accrues since permission inheritance per role reduces the number of distribution and revocation actions.

The present invention provides, in yet a further aspect, automatic propagation of updates of role-permission hierarchies to the access control lists of all objects affected by such updates. The updates of role-permission hierarchies include, but are not restricted to, (1) changes of role-permission inheritance, (2) creation and registration of new objects and assignment to roles, or object deletion and de-registration, and (3) distribution and revocation of permissions to roles. The automatic propagation is achieved through several specific operations on the role hierarchies, which include: (1) role instantiation, (2) abstract object and permission instantiation, (3) creation and deletion of inheritance relationships, (4) granting and revoking permissions to/from a role, (5) creation and deletion of a role, (6) creation and deletion of object instances, (7) de-registering an object and its permissions.

The present invention provides, in one aspect, per-role and per user review of permissions and requires neither redundant storage and additional administrative actions nor exhaustive searches of system resources. This is achieved through the association of a role with (1) a set of abstract objects and their permissions, (2) a set of abstract object instances and their permissions, and (3) permission and membership relationships. The invention provides, in a further aspect, the ability to determine whether two or more roles (or users) share permissions to objects. This ability provides support for he implementation and testing of generalized SOD (Separation Of Duty) policies and operational SOD policies. Generalized SOD policies specify which permissions two or more users or roles can share (if any), regardless of the set of objects and applications that may be accessible to those users or roles. Operational SOD policies specify which sets of operations of an application two or more users or roles can perform, regardless of the set of objects and applications that may be accessible to those users or roles in that application.

This invention makes use, in a further aspect, of both local and global groups for the instantiation of roles on multiple computer hosts and for implementing nested groups. This enables the integration of extant host computers, which include local user accounts and groups defined on independent servers and workstations, within large distributed operating systems.

In a yet further aspect, this invention (1) provides the transition from and extant system state to an RBAC system state; i.e., a state in which the permissions of users and groups to objects are managed centrally and automatically using roles, and (2) removes the redundant user permissions to objects of a given state in the transition to the RBAC state (by the explicit identification of both membership and permission inheritance present in the current state).

The preferred embodiment of the invention is in the form of a client-server application, called the Access Control Center (ACC), which implements the inventive method of permission management across multiple host systems, whose access control security mechanisms are based on user accounts, groups, and access control lists.

The Preferred Embodiment Uses Both Role Hierarchies

In contrast with the existing RBAC systems, the preferred embodiment uses both role hierarchies (based on multiple permission-inheritance and membership inheritance) for automatic permission management. Actually, the preferred method used in our embodiment assumes that the two role graphs coincide, i.e.,

r₁→r₂ [symbol] r₁ [symbol] r₂,

even if that is not necessary.

New Instantiation Rule(s)

Rule 4. If the role graph is based on permission-inheritance, r1, r₂ are two roles such that r₁→⁺r₂, and r₂ has an instance (a group) on host system h or set of hosts d(h), then all permissions of r₂'s instance on h must also be permissions of r₁'s instance on h or d(h) (a user account or group).

Note that satisfying this rule in practice leads to permissions propagation to the instances of all r₂'s ascendants, which might be inefficient; however, this propagation is performed only when an instantiation, a grant or revocation of permissions, or a change in the role hierarchy is performed.

The following rule is a relaxation of Rule 4:

Rule 4′. If the role graph is based on permission-inheritance, u and r₂ are a user and a role such that u→⁺r₂, and r₂ has an instance (a group) on host system h or d(h), then all permissions of r₂'s instance on h or d(h) must also be permissions of u's instance on h or d(h) (a user account).

The following rule is even more relaxed than rule 4:

Rule 4″. If the role graph is based on both permission-inheritance and membership-inheritance, u and r₂ are a user and a role such that u→⁺r₂ , and r₂ has an instance (a group) on host system h or d(h), then either all permissions of r₂'s instance on h must also be permissions of u's instance on h (a user account), or u's instance must be a member of r₂'s instance.

This rule ensures that user account u has the correct computed permissions, where by “computed” we mean either direct permissions (access control list entries specifying user u), or indirect, obtained by u through membership in a group like r₂'s instance (access control list entries specifying the group containing u).

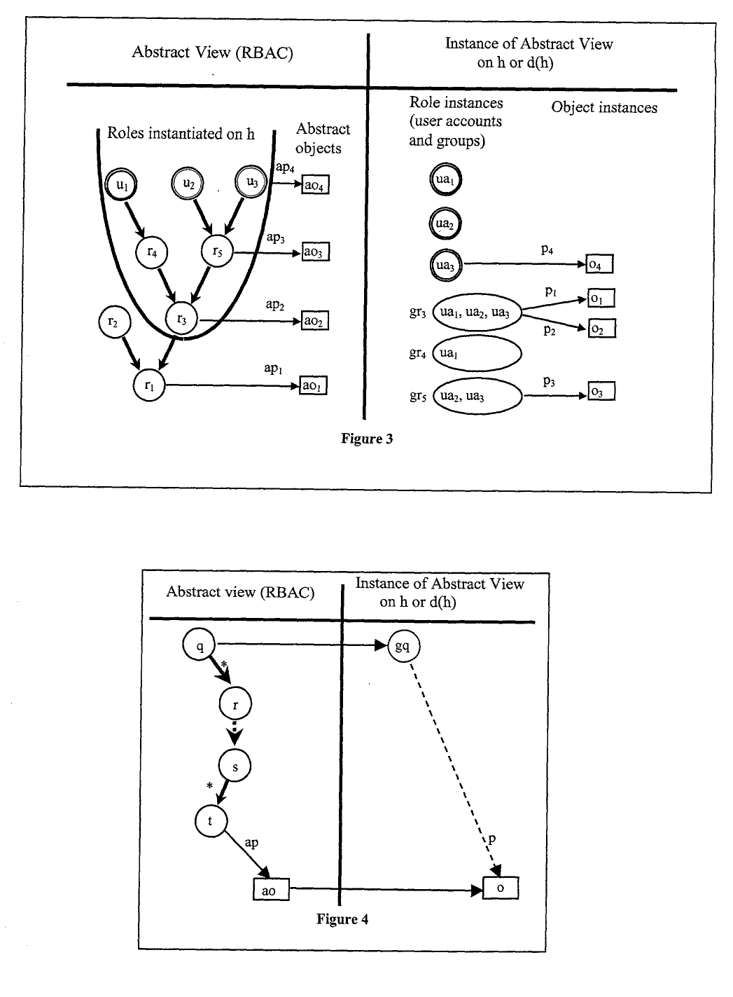

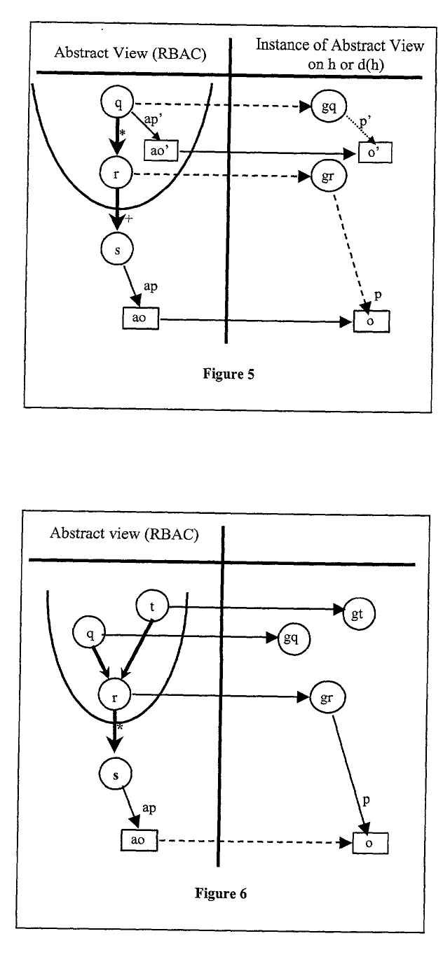

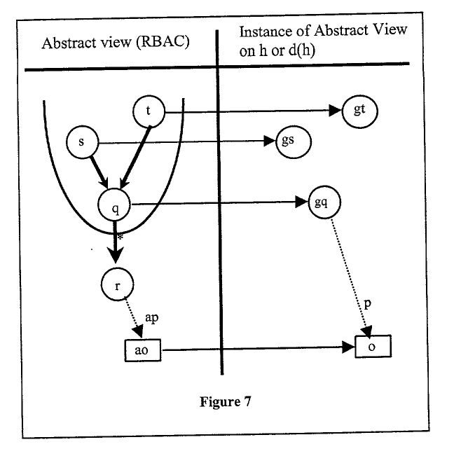

Rule 4″ can be applied in a different way to each role along an instantiated path in the role hierarchy as that of FIG. 3. For example, for r₃'s instance we can choose to include its permissions to those of user u₃; for r₅'s instance we can choose to insert u₃'s instance into it. Later in this section we will describe in detail the instantiation method used by our preferred embodiment.

Using the Group Nesting Mechanism in Instantiation Based on Membership-Inheritance

Rule 3 of the instantiation process used for membership-based role hierarchies states that whenever role r₂ inherits role r₁ (r₁ [symbol] r₂), all the members of r₁'s instance must become members of r₁'s instance. Satisfying this rule requires in some cases that the same large set of users be included in many different groups. Modem operating systems provide a group nesting mechanism, that allows to define once the large set of users as a group, and then include that group as a member of each group required to contain those users. Our preferred embodiment and method use a modified instantiation method for membership-based role hierarchies, which takes advantage of the group nesting mechanism. This section describes in detail the new instantiation method, which works under the following assumptions:

Assumption 1. A selected group of host computers compose a domain, controlled by one of the member hosts, called the domain controller.

Assumption 2. One can define a user or group global with respect to a domain, in the sense that the group is recognized by each of the domain's member hosts.

Assumption 3. One can define a user or group local with respect to a host computer, except for the domain controller, on which the users are always global.

Assumption 4. The operating system of a host computer allows the inclusion of a global group as a member of a local group.

We denote by domain(h) the domain that host system h belongs to. For each domain d, we denote by dc(d) the domain controller. instance(r, d) denotes a global user (if r is a user) or global group (if r is a role) with respect to the domain d. instance(r, h) denotes a local user or group account on the host h, except when h=dc(domain(h)), and r is a user, when it denotes a global user.

(a) When one instantiates r on the domain controller, the new instantiation method creates global users and/or groups. However, the administrator may select an option allowing creation of local groups on the domain controller.

(b) When one instantiates r on a regular host system in a domain, if r already has a global instance (i.e., r was instantiated on the domain controller as a global entity), nothing is done. However, the administrator may select an option allowing creation of a local instance and inclusion of the global instance into the local one.

(c) When one instantiates r on a regular host system in a domain, and r does not have a global instance, a local instance is created. The new method then examines the direct ascendants of r. For those with global instances, these instances are included in the local instance just created. For direct ascendants of r with local instances, the members of the local instances are included in the local instance just created.

For example, assume that r₁→r, r₂→r, r₃→r, and each of r₁, r₂, and r₃ has 1,000 users, with no common users. Also assume that we need to instantiate r on 20 hosts in a domain in order to grant those 3,000 users access to some resources. The old instantiation method applied to r on a host would create 3,000 new local accounts and four local groups on each host. Applying the new method to instantiate r₁, r₂, r₃ on the domain controller, then to instantiate r on each host, would create once 3000 global accounts and three global groups for r₁, r₂ and r₃, and then a local group for r on each of the 20 hosts, and would include the global groups for r₁, r₂, r₃ as members of the local group r on each host.

instantiate(r, h,

create_local_on_pdc=false,
create_local_even_when_global_exists=true)

{

if (h = pdc(domain(h)))

if (instance(r, domain(h)) or instance(r, h) exists) return;

else

if (instance(r, h) exists) return;

if (h = pdc(domain(h))) {

// h is the primary domain controller of its domain

| | |
|---|---|
| if (r is a user) | // r is a user |

| | |
|---|---|
| create instance(r, domain(h)); | // global user |

| | |
|---|---|
| else { | // r is a role |

if (create_local_on_pdc)

| | |
|---|---|
| create instance(r, h); | // local group, user choice |

else

create instance(r, domain(h));// global group, user choice

for (each p such that p→r) {

instantiate(p, h, create_local_on_pdc,

create_local_even_when_global_exists);

| | |
|---|---|
| if (p is a user) | // p is a user |

add instance(p, domain(h)) to

instance(r, h) or instance(r, domain(h)),
whichever exists;

| | |
|---|---|
| else { | // is a role |

// both r and p can have a local or global instance on h
if (p has global instance and r has local instance)

add instance(p, domain(h)) as a member of instance(r, h)

else

add each user in instance(p) to instance(r);

}

}

}

} else {

| // h is a workstation | |
|---|---|
| if (r is a user) { | // r is a user |

if (instance(r, domain(h)) exist and

not create_local_even_when_global_exist) return;

| | |
|---|---|
| create instance(r, h); | // local user |

| | |
|---|---|
| } else { | // r is a role |

if (instance(r, domain(h)) exist and

not create_local_even_when_global_exist) return;

| | |
|---|---|
| create instance(r, h); | // local group |

for (each p such that p→r) {

instantiate(p, h, create_local_on_pdc,

create_local_even_when_global_exists);

| // if p has a local instance, use it. | |
|---|---|
| // otherwise use its global instance. | |
| if (p is a user) { | // p is a user |

if (instance(p, h) exists)

add instance(p, h) to instance(r, h);

else

add instance(p, domain(h)) to instance(r, h);

| | |
|---|---|
| } else { | // p is a role |

if (instance(p, h) exists)

add all members of instance(p, h) to instance(r, h);

else

add instance(p, domain(h)) to instance(r, h);

}

}

}

}

}

Abstract Objects, Classes, and Permissions in RBAC

Our inventive method defines users and groups permissions on objects of host systems indirectly, through the use of so-called abstract objects and abstract permissions, assigned to roles. An abstract object is an entity exposing a series of attributes, the object class and object name being two of them. These two attributes uniquely identify the abstract object.

An object class should define the available abstract operations on objects of that class. For example, the class invoice could provide the abstract operation sign_invoice. It is worth to note that an operation also denotes the permission to execute that operation on a corresponding object.

If the abstract objects of a certain class can be instantiated on a host system, i.e., the abstract objects can be represented by objects of that host system, called instances, then the inventive method must provide means to translate an abstract permission to permissions appropriate for those instances. For example, an abstract permission of write can be translated to write_data, append, if the class contains objects that can be instantiated to regular files.

Our preferred embodiment allows any user to create a class of abstract objects and define its abstract permissions. The other users cannot modify the class unless they are granted the permissions to do so by the class creator. Also, only the class creator and the users granted permission to do so may create abstract objects of that class. That means that permissions like update_class and create_object must be among the abstract permissions associated with a class.

Using our preferred embodiment, one can grant abstract permissions on abstract objects to RBAC users and roles. The preferred embodiment stores the permissions using the usual mechanism of ACLs (Access Control Lists). Each abstract object has an associated ACL; each ACL entry specifies a user of roles and its allowed permissions on the corresponding abstract object.

Our preferred embodiment enables per-object review of permissions, as well as per-role and per-user review of permissions without recurring to exhaustive system searches. Our embodiment and method is different from other methods and implementations through the fact that it does not associate a list of capabilities with a role, which is redundant, and needs costly synchronization with the ACLs. Our inventive method only associates a role to a list of pointers to objects that are accessible to that role. The pointer to an object can be anything that uniquely identifies the object. For example, the combination of object class and name could be used as a pointer to the object. Our preferred embodiment uses an object identifier (OID), which is numeric, uniquely identifies the object, and is assigned when the abstract object is created. Even if a second abstract object with the same class and name is created after an abstract object is deleted, our embodiment assigns a different OID to it.

The role's associated OID list needs to be updated only when the administrator grants the role permissions to a new object; the update consists only of adding the new object's OID to the role's OID list.

The OID list of a role can become large and contain entries pointing to objects that that role has no longer access to, if a large number of additions and deletions of permissions on abstract objects is performed. It is worth to note that the algorithm for per-role review still works, but its efficiency decreases. For efficiency, the method may traverse the role's OID list once in a while, searching for abstract objects no longer accessible to that role and delete their OIDs from the list. Alternatively, when the role permissions on an abstract object are entirely revoked, the method can delete the OID for that abstract object from the associated OID list.

Notation

Let ROLES be the set of roles (including users) of the RBAC system. OBJECTS denote the set of (abstract) objects registered with the RBAC system. Different objects in OBJECTS may have different valid abstract operations, depending on the object type, or class. class(o) denotes the class of the object o. CLASSES denotes the set of object classes. ops(c), where c is an object class, denotes the set of operations valid for (objects of) class c. Depending on the context of use, an operation may also denote the permission to execute that operation on an object of appropriate class.

By name(o) we denote the name of object o. The name and class of an object uniquely specify the object for the human user.

By oid(o), where oεOBJECTS, we denote the object identifier of o. By obj(id) we denote the object having the object identifier id. The object identifier uniquely specifies the object.

Each object in OBJECTS has an associated access control list (ACL). acl(o) denotes the ACL associated to the object o. The list acl(o) contains 0 or more access control entries (ACE), each ACE being of the form “role:op₁, . . . ,opₙ”, where roleεROLES, and opᵢεops(class(o)), for i=1,n. Two different ACEs in the same ACL must specify different roles. In practice, the ACE's list of operations can be an access mask. The semantic of an ACE is the usual one: the specified role is allowed to perform each opᵢ on that object, but no other operation. By role(ace) and ops(ace) we respectively denote the role and (abstract) operations specified in the ACE ace.

Each role stores a list of pointers to the objects to which it has access. In our implementation, the pointer to the object is the object identifier. We denote by oidlist(r) the list of pointers (object identifiers) to objects accessible to role r.

Registering Abstract Objects

Registration of an object o with oid(o)=n requires that the class c of the object (and, by consequence, the valid operations on the object) be already defined. Also, registering an object requires that a default ACL be set on that object. The object pointer lists (oidlist) of the roles specified in the default ACL entries must be updated to reflect the new access rights of those roles. Then the registration of the object can be formally described as follows:

OBJECTS' = OBJECTS ∪ {o}
OIDS' = OIDS ∪ {n}
oid' = oid ∪ {o |→n}
class' = class ∪ {o |→ c}
acl' = acl ∪ {o |→ defaultACL}
for each ace in defaultACL do

let r = role(ace)
oidlist' = (oidlist \ {r|→ oidlist(r)}) ∪ {r |→
(oidlist(r) ∪ {n})}

Note that an empty default ACL (an ACL with 0 entries) ensures that no role has access to the associated object.

The registration of an object in ACC may be performed by any user that has the permission to create abstract objects. The permission to create abstract objects of a class is granted by the class creator, which must itself have the permission to create classes. This permission is obtained from the system administrator. The default values of ACL entries for an object can be set by the creator of the object class.

Per-role Review of Permissions

Assuming that the method associates a list of OIDs to a role to identify the abstract objects to which that role has access, the method for per-role review of permissions is very simple. For each OID in a role's associated list, the method obtains the abstract object and its ACL, and traverses the ACL looking for an entry specifying the role. When such an entry is found, the method extracts the role's permissions from it and lists them.

Per_role_review(r)
{

for (each p such that r→*p)

for (each id in oidlist(p))

// id is the oid of an object to which r might have access
// either directly, or through membership inheritance
for (each ace in acl(obj(id)))

// for each ACE in that object's ACL
if (role(ace) == p)

if (p == r)

print “directly”, name(obj(id)), class(obj(id)),

ops(ace);

else

print “inherits”, name(obj(id)), class(obj(id)),

ops(ace);

}

Instantiating an Abstract Object

Some abstract objects may be represented on host systems through “real” objects (i.e., files, directories, ports, etc.) This representation can be done in two ways: either an already defined abstract object is associated with a real object (operation called instantiation of the abstract object); or a real object is registered with the RBAC security system, meaning that an abstract object is created and associated with the real object. In either case, the actual object is called an instance of the abstract object.

In order to instantiate an abstract object into a real object, the class of the abstract object must support abstract operations that can be translated into appropriate actual operations for the real object. For example, an update abstract operation may translate to the {read, write} subset of operations supported by files, if the abstract class' objects instantiate to files.

We denote by instance(o, h) the real object associated with abstract object o on the host h where the real object is located. We denote by instance(op, cl) the set of actual operations corresponding to the abstract operation op of the object class cl. For the previous example, instance(update, FileClass)={read, write}, where FileClass is an imaginary class denoting the class of file objects.

We extend this functions to sets of abstract operations in the usual way, so that we can also write instance({update}, FileClass)={read, write}.

Every abstract object is associated with the list of its instances on all hosts of the RBAC system.

We can extend the algorithm for per-role-review of access rights to object instances in the following way:

Per_role_review_of_access_rights_to_actual_objects(r)
{

for (each p in authorized_roles(r)) //i.e., r→*p

for (each id in oidlist(r))

// id is the oid of an abstract object
for (each ace in acl(obj(id)))

// for each ACE in that object's ACL
if (role(ace) == p)

for (each instance of obj(id))

print name of instance, location of instance,

instance(ops(ace), class(obj(id))

}

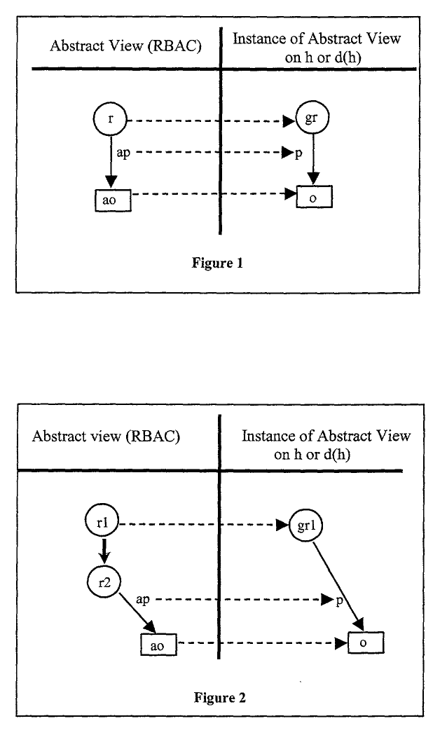

The instantiation operation for roles, abstract objects and permissions is shown in the diagram of FIG. 1. If role r has the abstract permission ap on abstract object ao of class cl, and both role r and object ao are instantiated on a host computer h (or a set of host computers, d(h)), then gr =instance(r, h) should have the permission p (which is an instance(ap, cl) on o =instance(ao, h) (viz. FIG. 1).

A further aspect of the instantiation operation for roles, abstract objects and permissions is shown in the diagram of FIG. 2. In this figure, note that not all roles along an inheritance path may be instantiated. For example, assume that role r₁→r₂, r₁ is instantiated on h while r₂ is not, and r₂ has the abstract permission ap on the abstract object ao, which is instantiated on h (viz., FIG. 2). In this case, instance(r₁, h) must have the instance of r₂'s permission on the instance(ao, h), in additions to its own permissions.

FIG. 3 illustrates a further aspect of the method for permission management in RBAC systems contained in this invention. The left half of the figure shows a portion of the directed acyclic graph of roles, where some roles and users have been granted abstract permissions on some abstract objects. The right half of the figure shows the relationships between instances of users, roles, permissions, and objects built by the inventive method. rᵢ, i=1, . . . ,5, denote roles, uᵢ, i=1, . . . ,3, denote users, the thick arrows denote role graph arcs, aoᵢ, i=1, . . . 4, denote the abstract objects, the thin arrows labeled apᵢ, i=1, . . . ,4, denote abstract permissions. uaᵢ, i=1, . . . ,3, denote user accounts (instances of users uᵢ), grᵢ, i=3, . . . ,5, denote groups (instances of rᵢ), oᵢ denote objects (instances of aoᵢ), and the thin arrows labeled pᵢ, i=1, . . . ,4, denote permissions.

FIG. 3 shows the case when the role view defined by role r₃ and abstract objects ao₁, ao₂, ao₃, ao₄, have been instantiated on h, or d(h). Both permission inheritance and membership inheritance are used to increase the efficiency of permission distribution and access authorization. Role instance gr₃ is granted permission p₁ on object instance o₁ because role r₃ inherits the permissions of role r₁. Role instance gr₃ is granted permissions p₂ on object instance o₂ because role r₃ has abstract permission ap₂ as its own permission on abstract object ao₂. However, permission p₃ is not propagated to the instances of role r₃'s ascendants (i.e., to role instances gr₄, gr₅, and users ua₁, ua₂, ua₃), because users ua₁, ua₂, ua₃ all are members of role instance gr₃ (by membership inheritance), and thus have permission p₃.

Role Inheritance and Permissions

Assume that r, sε ROLES, and the RBAC administrator sets up the inheritance r→s. The result should be that any user u of role r (i.e., u→*r) inherits the access rights of role s and all its descendants. In the RBAC view, the access rights inheritance is solved through membership inheritance: now, u→*t, where t is s or any of its descendants, so that u is considered by the RBAC system a member of t, and thus inherits all access rights of t.

Things are very different on the hosts controlled by the RBAC system. Assume that u and r have instances on a host h. Instances preserve role membership, so that instance(u,h)εinstance(r,h). Further assume that s has no instance on h or on domain(h), but that s has some permissions on objects that have instances on h. There is no way for u or r to inherit those permissions, unless the procedure which sets up the inheritance r→s explicitly adds them to the instance(r, h).

The following algorithm sets permissions when the inheritance r→s is established and must be applied after the inheritance is established. If s is instantiated on a host h or on domain(h), nothing has to be done regarding permission inheritance on that host. Indeed, instance(s, h) already has the correct permissions, and the algorithm to set r→s creates instances for r and its ascendants, and includes them into instance(s, h), so that r and its ascendants inherit s's permissions through membership.

Before examining the case when s is not instantiated on h or on domain(h), we need a definition. We say that user/role q is a first ascendant of r (including r) instantiated on h or domain(h) if: q has an instance on h or on domain(h), q is an ascendant of r (i.e., q→*r), and there is no proper descendant of q with the same properties (i.e., there is no q′ such that q→⁺q′, q′ has an instance on h or domain(h), and q′→*r). We denote by fia(r, h) the set of all first ascendants of r (including r) instantiated on h).

If s is not instantiated on h or on domain(h), then all first instantiated ascendants of r (including r) must inherit permissions from s and its descendants on objects instantiated on h.

Set_permissions_in_case_set_inheritance(r, s)
{

for (each host h)

if (there is instance(s,h))

| | |
|---|---|
| return; | // nothing to do |

else if (there is instance(s,domain(h))

| | |
|---|---|
| return; | // nothing to do |

| | |
|---|---|
| else { | // s has no instance (local or global) on h |

for (each q in fia(r, h)

// for each q first ascendant instantiated on h
for (each t such that s→*t)

// for each t descendant of s (including s)
// note that t has no instance on h or domain(h)
// find the objects with instances on h
// on which t has some permissions
for (each id in oidlist(t))

if (obj(id) has an instance on h)

for (each ace in acl(obj(id))

if (role(ace) == t)

// add those permissions to q's instance
add permissions instance(ops(ace), cl) to

instance(q, h) or instance(q, domain(h)),
where cl is class(obj(id));

}

}

Role Instantiation and Permissions

Assume that rε ROLES, r has no instances on host h or on domain (h), and the RBAC administrator instantiates r on h or on domain(h). r and all its ascendants will be instantiated on h or on domain(h). In the RBAC view we do not need to make any changes regarding permissions. However, in the host or domain view, we need to ensure that each newly created user/role instance inherits the correct permissions from descendant roles.

First, note that no descendant of r (i.e., a role s such that r→⁺s) has an instance on h or domain(h), because otherwise r would have been already instantiated.

Second, note that if a descendant s of r (i.e., r→⁺s) has some permissions on an abstract object ao that has an instance on h, then instance(r, h) must be granted those permissions on instance(ao, h).

Third, note that if q→⁺t→*r, then instance(t, h)'s permissions are inherited by instance(q, h) through membership, because instance(q, h) is included in instance(t, h) by the instantiation algorithm.

Fourth, note that if q→*r, then we have to grant instance(q, h) the permissions granted directly to q on abstract objects.

Set_permissions_in_case_instantiate_role(r, h)
{

for (each proper descendant s of r, i.e., r→+s)

for (each id in oidlist(s))

if (obj(id) has an instance on h)

for (each ace in acl(obj(id))

if (role(ace) == s)

// add those permissions to r's instance
add permissions instance(ops(ace),cl) to

instance(r, h) or instance(r, domain(h)),
where cl is class(obj(id));

for (each ascendant q of r, i.e., q→*r)

for (each id in oidlist(q))

if (obj(id) has an instance on h)

for (each ace in acl(obj(id))

if (role(ace) == q)

// add those permissions to q's instance
add permissions instance(ops(ace),cl) to

instance(q, h) or instance(q, domain(h)),
where cl is class(obj(id));

}

Object Instantiation and Permissions

Assume that the RBAC administrator instantiates the abstract object aoεOBJECTS on a host h. Some role s may have permissions on object ao. First, note that if role s has no instance on h or domain(h), nothing needs to be done to s regarding permissions. However, if there are other roles which inherit s's permissions and which have instances on the host h or domain(h), then the permissions of those instances must be updated. It suffices to consider only the principals of the views instantiated on h or on domain(h), and to update the permissions of those principals' instances on h or domain(h).

Second, if roles has an instance on h or on domain(h), then the permissions of its own instances on h must be updated when the administrator instantiates ao.

Set_permissions_in_case_instantiate_object(ao, h)
{

if (acl(ao) is empty)

// no role has permissions on abstract object ao
return;

for (each ace in acl(ao)) {

s = role(ace);
perm = instance(ops(ace), class(ao));
if (s has an instance on h or domain(h))

grant instance(s, h) or instance(s, domain(h)) the

permission perm;

else {

for (each principal r of host h or of domain(h)) {

if (r→* s)

grant instance(r, h) or instance(r, domain(h)) the

permission perm;

}

}

}

Granting Permissions

Assume that an abstract object ao has an instance on host h, and the RBAC administrator grants role r some permission on ao. Let q be one of the ascendants of r (including r), q→*r. If q does not have an instance on h or on domain(h), then nothing needs to be done to q regarding permissions. If q has an instance on h or on domain(h), then the permissions of role r on ao must be translated to permissions of instance(q, h) or instance(q, domain(h)) on instance(ao, h). Note that this has to be done only for q being a first ascendant of r instantiated on h or domain(h); the instances of the other ascendants will inherit the permissions through membership.

Set_permissions_in_case_grant_permissions(r, ao)
{

for (each host h on which ao has an instance)

for (each q in fia(r, h)) {

perms = 0;
for (each ace of acl(ao)) {

v = role(ace);
if (q→*role(ace))

perms = perms | instance(ops(ace), cl),

where cl is class(ao);

}
grant instance(q, h) or instance(q, domain(h))

permissions perms on instance(ao, h);

}

}

Revoking Permissions

Revoking all or some permissions on an abstract object ao from a user/role r is simple if one can get the current permissions of r on ao. Indeed, all one has to do is to “and” the current permissions with the negation of permissions to be revoked, and then grant r the new permissions on ao. Of course, if the new permission set is empty, then one has to delete the ACE for role r from acl(ao), and delete the pointer to ao from oidlist(r). As always, if there is no instance(ao, h) on any host h, then revoking permissions is completed.

The case when the abstract object ao has an instance on host h is treated also as a “grant permissions” operation. The algorithm remain the same, with only a slight modification to allow for the deletion of the ACE for instances, h) from the ACL of instance(ao, h) if the new permission set is empty.

Destroying Role Inheritance and Permissions

Assume that p, rε ROLES, p→r, and that the RBAC administrator wants to destroy the inheritance p→r.

Regarding the permissions of p and its ascendants on abstract objects, nothing needs to be done, because these roles will no longer inherit r's permissions, unless they are inherited on some other path in the role graph. Indeed, a user u of role p, for example, will no longer be a user of r, and, thus, u will lose any permission acquired by inherited membership from r; all other permissions (own or inherited from other descendants) remain valid.

However, the permissions of each instance(q, h), where q is an ascendant of p with such an instance, must be recalculated. Note that recalculating permissions for only the instances of the first instantiated ascendants of p might not be enough. Indeed, consider the following scenario. Assume q→p, and further assume that the administrator instantiated q while p→r. Then instance(q, h) received some permissions from the descendants of r not instantiated, but having permissions on objects with instances on h. Assume that next, the administrator instantiated p still while p→r. Then instance(p, h) received some permissions from the descendants of r not instantiated, but having permissions on objects with instances on h. Now that the administrator deletes the inheritance p→r, permissions both for instance(q, h) and instance(p, h) must be recalculated, even if only p is a first instantiated ascendant.

The following algorithm recalculates the permissions for instances of all instantiated ascendants q of p (including p). As always, we only need to propagate permissions up to q along a chain of uninstantiated descendants of q.

recalculate_permissions_in_case_destroy_inheritance(p, r)
{

for (each host h)

// Recalculate permissions for all instantiated
// ascendants of p, including p
for (each q such that q→*p, and instance(p, h) exists

recalculate_perms(q, h)

}
// The following procedure assumes that q has an instance on h.
// For a direct descendant of q which has an instance on h,
// nothing has to be done, because membership is inherited
// between user/role instances.
// For a direct descendant s of q which does not have
// an instance on h, take all descendants t of s, and add t's
// permissions on objects with instances on h to q's permissions.
recalculate_perms(q, h) {

// first delete the old permissions for instance(q, h)
for (each id in oidlist(q))

if (obj(id) has an instance on h)

// delete the ACE for role q (if it exists)
for (each ace in acl(obj(id)))

if (role(ace) == q)

delete ace from acl(obj(id))

// next, set q's own permissions

for (each id in oidlist(q))

if (obj(id) has an instance on h)

for (each ace in acl(obj(id))

if (role(ace) == q)

// add those permissions to q's instance
add permissions instance(ops(ace), cl) to

instance(q, h) or instance(q, domain(h)),
where cl is class(obj(id));

// next, propagate permissions from q's descendants to q

for (each s such that q→s)

if (there exist instance(s, h)) {

// do not propagate perms from s to q, because
// instance(q, h) is included in instance(s, h)

} else {

// propagate permissions on object instances from s
// and its descendants to q
for (each t such that s→*t)

for (each id in oidlist(t))

if (obj(id) has an instance on h)

for (each ace in acl(obj(id))

if (role(ace) == t)

// add those permissions to q's instance
add permissions instance(ops(ace),cl) to

instance(q, h) or instance(q, domain(h)),

where cl is class(obj(id));

}

}

Deleting a Role

Assume that the RBAC administrator selects role rεROLES for deletion.

First, the RBAC system automatically removes r from the directed acyclic graph: all inheritance relations involving r are deleted. Moreover, every direct ascendant of r is made a direct ascendant of every direct descendant of r, in order to preserve the permission inheritance.

Next, the RBAC system removes r from the ACLs of all abstract objects accessible to r. The ascendants and descendant of r receive the correct permissions, due to the role membership inheritance. This step involves a traversal of oidlist(r). Now oidlist(r) can be deleted too.

Next, the RBAC system recalculates permissions for the instances of all of r's ascendants (some ascendants could loose permissions resulting from r's abstract permissions on some abstract objects). As in “Destroying Role Inheritance and Permissions”, recalculating permissions for only the instances of the first instantiated ascendants of r might not be enough.

Next, the RBAC system deletes all r's instances on hosts.

Finally, the role r is deleted.

The first of the following algorithms presents the deletion of r from the access control lists of its accessible abstract objects, and the deletion of oidlist. The second algorithm recalculates permissions for the r's ascendants.

delete_role_from_acls(r)
{

for (each id in oidlist(r))

for (each ace in acl(obj(id))

if (role(ace) == r) delete ace from acl(obj(id))

delete oidlist(r)

}
recalculate_permissions_in_case_delete_role(r)
{

for (each host h)

// Recalculate permissions for all instantiated
// ascendants of r, excluding r
for (each q such that q→+r, and instance(r, h) exists

recalculate_perms(q, h)

}
where recalculate_perms is the previous function.

Destroying a Role Instance and Permissions

Assume that pε ROLES has an instances on host h or on domain(h), and the RBAC administrator destroys instance(p, h) or instance(p, domain(h)). Note that in order for this administrative operation to be possible, no descendant of p can have an instance on h or domain(h).

By deleting instance(p, h) or instance(p, domain(h)), the ACEs corresponding to that instance in the ACLs of real objects will be automatically destroyed by the operating system, so we don't need to be concerned about them. Also, no ACEs for abstract objects need to be modified.

The only action to be done is to recalculate the permissions of all direct ascendants of p, which are still instantiated on h or domain(h).

recalculate_permissions_in_case_destroy_instance(p, h)
{

// Recalculate permissions for all direct ascendants
// of p, which are instantiated on h or domain(h)

for (each q such that q→p)

recalculate_perms(q, h)

}
where recalculate_perms(q, h) is exactly the procedure from the previous algorithm.

Destroying an Object Instance and Permissions

Assume that abstract object o has an instance on a host h, and the RBAC administrator wants to destroy that instance. The ACL for that instance will be automatically deleted by the operating system. The list of instances stored in the abstract object will be updated to reflect the deletion of that instance.

De-Registering an Object and Permissions

De-registering an object does not define whether its instances get destroyed or what permissions will have afterwards. Its instances simply are no longer controlled by the RBAC security system. The abstract object is destroyed together with its access control list and its list of instances. Any pointers to the abstract object within oidlists are deleted also.

de₋register₋object(o)
{

for (each ace in acl(o)) {

let r=role(ace)
delete oid(o) from oidlist(r)

}
delete object o (together with acl(o))

}

Transition to an RBAC State

The method of this invention allows the transition from an extant method of permission management at the granularity of individual users, group and object to automatic permission management using roles in RBAC. Specifically, the method allows the derivation of (1) a directed acyclic graph of roles representing both membership and permission inheritance, (2) abstract objects, and (3) abstract permissions, from the user account, group, and access control list and permission structures of extant operating systems. The method further allows the incremental transition from an extant permission management system to automatic permission management in RBAC.

For global users and groups, the method that defines the directed acyclic graph of roles from extant operating systems comprises the following steps:

all the group definition structures of the underlying operating system and applications are searched to determine the membership-inheritance relationships among these groups. This is performed using the existing application programming interfaces of operating systems by determining, for any two groups of the host of set of hosts, whether all users or groups that are members of the first group are also members of the second group.

the access control lists associated with the objects of the operating system are searched, and all permissions of every group and of every user to the objects of every host or set of hosts are determined.

the permission-inheritance relationships among groups and among users and groups are found. This is performed using the existing application programming interfaces of operating systems and determining, for any two groups of the host or set of hosts, whether all permissions to a set of objects of one group are also permissions to the same set of objects of the other group.

the identification of operating system and application groups on a host or set of hosts whose identifiers are used in application codes for user membership or privilege tests. These groups and any other groups reserved by the operating system for permission administration are assigned roles that are marked as “pre-existing.” The step of assignment of a role to a group further comprises the steps of defining (1) a role identifier and name; and (2) abstract objects whose instantiations are the objects accessible to the group; and (3) abstract permission whose instantiations are the permission to objects accessible to the group.

the remaining operating system and application groups are assigned different role identifiers.

the membership- and permission-inheritance relationships found among the operating system and application groups are transferred to the roles assigned to those groups. This transfer is performed by defining, for any two roles assigned to groups of the host of set of hosts, an inheritance relationship between the two roles if and only if that inheritance relationships exists between the groups assigned to those roles. A generic RBAC role is defined such that any role that has no other membership inheritance relationship with any other roles is membership inherited by the generic RBAC role.

For local users and groups, the method that defines the directed acyclic graph of roles from extant operating systems comprises the following steps:

all the group definition structures of the underlying operating system and applications on a given host are searched to determine the membership-inheritance relationships among these groups. This is performed using the existing application programming interfaces of operating systems as follows: (1) for any two local groups on the same host, the methods determines whether all members of the first group are also members of the second group; and (2) for a global and a local group the methods determines whether the global group is a member of the local group.

the access control lists associated with the objects of the operating system on a host are searched, and all permissions of every group and of every user to the objects of every host are determined.

the permission-inheritance relationships among groups and among users and groups are found. This is performed using the existing application programming interfaces of operating systems and determining, for any two local groups of a host, or a global and a local group, whether all permissions to a set of objects of one group are also permissions to the same set of objects of the other group.

the identification of operating system and application groups on a host or set of hosts whose identifiers are used in application codes for user membership or privilege tests. These groups and any other groups reserved by the operating system for permission administration are assigned roles that are marked as “pre-existing.” The step of assignment of a role to a group further comprises the steps of defining (1) a role identifier and name; and (2) abstract objects whose instantiations are the objects accessible to the group; and (3) abstract permissions whose instantiations are the permissions to objects accessible to the group.

the remaining operating system and application groups are assigned different role identifiers.

the membership- and permission-inheritance relationships found among the operating system and application groups are transferred to the roles assigned to those groups. The transfer of membership inheritance, whereby a second role inherits the membership of a first role, can be performed only if for any host where the second role has an instance the first role also has an instance, and the members of the first role instance are included in the instance of the second role. The transfer of permission inheritance, whereby a first role inherits the membership of a second role, can be performed only if for any host where the second role has an instance the first role also has an instance, and the permissions of the second role instance are included in the permissions of the instance of the first role.

For both local and global users and groups, the method defines the following operations that can be performed on the directed acyclic graph of roles obtained:

the transformation of permission-inheritance relationships into membership-inheritance relationships. This step comprises the further steps of (1) finding pairs of roles that have a permission inheritance relationship between them such that the first role inherits the permissions of the second role, and do not have a membership inheritance; and (2) establishing a membership-inheritance relationship whereby the second role inherits the membership of the first. Step (2) comprises adding the members of the first role instance to the instance of the second role and to all instances of the roles that inherit the membership of the second role.

the removal of redundant permissions. A permission is redundant if it is granted to more than one role on the same membership-inheritance path of the directed acyclic graph of roles. Removal of redundant permissions is performed bottom-up, against the direction of permission-inheritance arcs, along a permission inheritance path as follows: (1) for each pair of roles on the path, the redundant permission is deleted from the instance of the inheritor role of the pair, and (2) whenever the pair includes adjacent roles of the permission graph, the permission-inheritance relation between the two roles is also deleted.

the merging of two roles. A first role is merged into a second role in the membership-inheritance graph if (1) all direct ascendants of the first role, except the second role, become direct ascendants of the second role, (2) all direct descendants of the first role, except the second role, become direct descendants of the second role, and (3) the permissions of the first role are granted to the second role.

the cloning of a role. A first role is cloned to obtain a second role if (1) a second role is created, (2) the direct ascendants of the first role become direct ascendants of the second role, (3) the direct descendants of the first role become direct descendants of the second role, and (4) the permissions of the first role are granted to the second role.

All these operations are accomplished using the operations already defined in this invention; i.e., creation of a role; per-role-review of privileges, instantiation of an abstract object, instantiation of a role; instantiation of a user; establishment role inheritance; granting permission to a role; revoking permissions; destruction of a role; destruction of a role instance; destruction of an abstract object; and de-registering an object instance.

The directed acyclic graph of roles thus obtained, which represents both membership and permission inheritance of extant operating systems, is updated further, if necessary, to implement the desired access control policies of an enterprise, using the role-graph update operations defined above. Furthermore, the directed acyclic graph of roles thus obtained can be updated incrementally as new users, groups, and objects are added to the system, or periodically, using the graph update steps defined.

One of skill in the art would recognize that the above system describes the typical components of computer systems connected to an electronic network. It should be appreciated that many other similar configurations are within the abilities of one skilled in the art, and all of these configurations could be used with the method of the present invention. Furthermore, it should be recognized that the computer system and network disclosed herein can be programmed and configured, by one skilled in the art, to implement the method steps discussed further herein. It would also be recognized by one of skill in the art that the various components that are used to implement the present invention may comprised of software, hardware, or a combination thereof.

It should be noted that although the examples provided herein show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the invention. Likewise, software and web implementation of the present invention could be accomplished with standard programming techniques. It should also be noted that the word “component” as used herein and in the claims is intended to encompass implementations using one or more lines of software code, and/or hardware implementations, and/or equipment for receiving manual inputs and permitting manual implementation.

The foregoing description of a preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined the claims appended hereto, and their equivalents.

What is claimed is:

1. A method for the automatic distribution, review and revocation of user and group permissions to objects through management of role permissions to abstract objects in a computing environment comprises a role-based access control system that includes a directed acyclic graph representing role-membership inheritance relationships and a directed acyclic graph representing role-permission inheritance relationships, said method comprising:
associating each role with the set of abstract objects accessible to the said role, said association requiring neither redundant storage and maintenance of permissions nor exhaustive system searches.

2. The method of claim 1, further comprising:
defining and managing the abstract permissions of a role on abstract objects; and
finding, retrieving, and displaying abstract permissions of a role on abstract objects; and
adding an abstract object to the set of abstract objects associated with a role whenever said abstract object becomes accessible to said role; and
deleting an abstract object from the set of abstract objects associated with a role whenever said abstract object becomes inaccessible to said role.

3. The method of claim 2, further comprising:
creating, finding, retrieving, displaying, and deleting instances of a role on a host computer or set of host computers, using group nesting and a directed acyclic graph of role-membership inheritance; and
creating finding, retrieving, displaying, and deleting object instances of abstract objects on a host computer or set of host computers; and
registering objects as instances of abstract objects on a host computer or set of host computers; and
deriving permissions of a role instance on object instances from the abstract permissions of said role on said abstract objects; and
registering permissions on objects as instances of abstract permissions on abstract objects on a host computer or set of host computers; and
finding, retrieving, and displaying the permissions derived from abstract permissions defined on abstract objects.

4. The method of claim 3, further comprising the steps of:
creating an instance of a RBAC user on a set of host computers, said user instance being called global with respect to said set of host computers; and
creating an instance of a RBAC user on a host computer, said user instance being called local with respect to said host computer, unless said host computer is used to control a set of host computers, in which case the instance is called global with respect to said set of host computers; and
creating a role instance on a set of host computers, said role instance being called global with respect to said set of host computers; and
creating a role instance on a host computer, said role instance being called local with respect to said host computer, unless said host computer is used to control a set of host computers, in which case one can select whether the instance will be local with respect to said host computer, or global with respect to said set of host computers; and
including a local user instance in a local role instance, if said user is assigned to said role, and both said instances were derived on the same host computer; and
including a global user instance in a local role instance, if said user is assigned to said role, and said local role instance was derived on a host computer included in the set of host computers used to derive said global user instance; and
including the global user instance in a global role instance, if said user is assigned to said role, and both said instances were derived on the same set of host computers; and
including the members of a local instance of a first role in a local instance of a second role, if the second role inherits the membership of the first role, and both said instances were derived on the same host computer; and
including the global instance of a first role as a member of a local instance of a second role, if the second role inherits the membership of the first role, and said local instance was derived on a host computer included in the set of host computers used to derive said global instance; and
including the members of a global instance of a first role in a global instance of a second role, if the second role inherits the membership of the first role, and both said instances were derived on the same set of host computers.

5. The method of claim 3, further comprising:
computing, displaying, reviewing, and listing the permissions of any role to abstract objects; and
computing, displaying, reviewing, and listing the permissions of any role to object instances; and
computing, displaying, reviewing, and listing the permissions of any role instance to object instances.

6. The method of claim 5, further comprising:
determining whether two or more roles share permissions on any abstract objects; and
determining whether two or more roles share permissions on any object instances; and
determining whether two or more role instances share permissions on any object instances; and
implementing and testing any policy that is satisfied by the determination of whether two or more roles share permissions to abstract objects; and
implementing and testing any policy that is satisfied by the determination of whether two or more roles share permissions to object instances; and
implementing and testing any policy that is satisfied by the determination of whether two or more role instances share permissions to object instances.

7. The method of claim 6, further comprising:
implementing and testing generalized separation-of-duty policies; and
implementing and testing operational separation-of-duty policies.

8. The method of claim 3, further comprising:
automatic distribution of permissions on object instances to role instances whenever new permission-inheritance relations are established among roles; and
automatic distribution of permissions on object instances to role instances whenever new roles are added to the directed acyclic graph; and
automatic distribution of permissions on object instances to role instances whenever a new role instance is created for a role on a host computer or set of host computers; and
automatic distribution of permissions on object instances to role instances whenever a new object instance is created for an abstract object on a host computer or set of host computers; and
automatic distribution of permissions on object instances to role instances whenever a new permission is granted to a role.

9. The method of claim 3, further comprising:
automatic revocation and recalculation of permissions on object instances for role instances whenever permission-inheritance relations among roles are removed; and
automatic revocation and recalculation of permissions on object instances for role instances whenever roles are removed; and
automatic revocation and recalculation of permissions on object instances for roles instances whenever an abstract object is removed; and
automatic revocation and recalculation of permissions on object instances for role instances whenever a permission is revoked from a role.

10. The method of claim 3, further comprising:
scaleable, automatic, distribution, revocation, and recalculation of permissions of role instances to object instances that support efficient access authorization.

11. The method of claim 10, further comprising:
adding a new permission-inheritance arc to the directed acyclic graph between a first role called inheritor role and a second role called the inherited role whereby the inheritor and all its ascendant roles inherit all the permissions of the inherited role and its descendant roles in the directed acyclic graph; and
automatically selecting the roles that do not have instances on a host computer or set of host computers from the set comprises the said inherited role and its descendants in the directed acyclic graph; and
automatically computing a set of permissions by mapping the abstract permissions of said selected roles on all abstract objects that do have instances on said host computer or set of host computers; and
automatically granting said computed permissions to the instance of each first encountered role instantiated on said host computer or set of host computers by traversing the directed acyclic graph in the direction opposite to that of the inheritance arcs on any path starting from the inheritor role.

12. The method of claim 11, further comprising:
removing a permission-inheritance arc from the directed acyclic graph between a first role called inheritor role and a second role called the inherited role; and
automatically recalculating permissions and granting said permissions to the instance of each first encountered role instantiated on a host computer or set of host computers, by traversing the directed acyclic graph in the direction opposite to that of the inheritance arcs on any path starting from the inheritor role.

13. The method of claim 11, further comprising:
revoking an abstract permission to an abstract object from a role where said abstract object has an instance on a host computer or set of host computers; and
automatically updating the association between the said role and the set of accessible abstract objects; and
automatically recalculating permissions and granting said permissions to the instance of each first encountered role instantiated on a host computer or set of host computers, by traversing the directed acyclic graph in the direction opposite to that of the inheritance arcs on any path starting from the said role.

14. The method of claim 11, further comprising
deleting a role from the directed acyclic graph, further comprising:
selecting a role for deletion from the directed acyclic graph;
automatically removing the said role from the access control lists of all abstract objects accessible to said role; and
automatically deleting the association between said role and all abstract objects accessible to said role; and
automatically recalculating permissions and granting said permissions to the instance of each first encountered role instantiated on a host computer or set of host computers, by traversing the directed acyclic graph in the direction opposite to that of the inheritance arcs on any path starting from the any direct ascendant of the selected; and
automatically deleting all instances of the selected; and
automatically deleting the selected role from the directed acyclic graph.

15. The method of claim 10, further comprising:
creating an instance of a role on a host computer or set of host computers; and
automatically selecting the roles that did not have instances on said host computer or set of host computers prior to the creation of said role instance, wherein the selection is performed from said role and its descendant roles in the directed acyclic graph; and
automatically computing a set of permissions by mapping the abstract permissions of said selected roles on all abstract objects that do have instances on said host computer or set of host computers; and
automatically granting said computed permissions to said role instance just created.

16. The method of claim 10, further comprising:
creating an instance of a user on a host computer or set of host computers; and
automatically selecting the roles that did not have instances on said host computer or set of host computers prior to the creation of said user instance, wherein the selection is performed from said user and its descendant roles in the directed acyclic graph; and
automatically computing a set of permissions by mapping the abstract permissions of said selected roles on all abstract objects that do have instances on said host computer or set of host computers; and
automatically granting said computed permissions to said user instance just created.

17. The method of claim 10, further comprising:
granting a role an abstract permission to an abstract object that has an instance on a host computer or set of host computers and automatically causing the said role's ascendant roles and users to inherit the said abstract permission; and
automatically updating the association between the said role and the set of accessible abstract objects; and
automatically mapping the said abstract permission of said role on said abstract object to a set of permissions for the object instance; and
automatically granting said set of permissions to the instance of each first encountered role instantiated on said host computer or set of host computers by traversing the directed acyclic graph in the direction opposite to that of the inheritance arcs on any path starting from the role being granted the abstract permission.

18. The method of claim 10, further comprising:
instantiating an abstract object on a host computer or set of host computers; and
automatically reading the access control list of the abstract object and computing the set of roles that have abstract permissions to the said abstract object; and
for each role in the said set, automatically mapping the abstract permissions of said role on said abstract object to a set of permissions for the object instance; and
automatically granting said set of permissions to the instance of each first encountered role instantiated on said host computer or set of host computers by traversing the directed acyclic graph in the direction opposite to that of the inheritance arcs on any path starting from said role.

19. The method of claim 10, further comprising
deleting an abstract object, including the steps:
automatically finding and deleting all instances of said abstract object and their access control lists; and
automatically reading the access control list of said abstract object and, for each role found in the said access control list, removing the said abstract object from the association between said role and its set of accessible abstract objects; and
automatically deleting the said abstract object and its access control list.

20. The method of claim 10, further comprising:
deriving a directed acyclic graph of roles representing both membership and permission inheritance, abstract objects, and abstract permissions, from the user account, group, and access control list and permission structures of extant operating systems; and
performing the incremental transition from an extant permission management system to automatic permission management in RBAC.

21. The method of claim 20, further comprising:
deriving membership-inheritance and permission-inheritance relationships among the existing user accounts and groups; and
creating roles and assigning selected user accounts and groups to said roles; and
deriving membership-inheritance and permission-inheritance relationships among said roles and obtaining a directed acyclic graph for each type of inheritance relationship; and
transforming the said directed acyclic graphs into a single directed acyclic graph of membership inheritance that preserves the permission of the user accounts defined by permission inheritance.

22. A computer program product containing computer readable code for causing a machine to perform the following method steps:
automatic distribution, review and revocation of user and group permissions to objects through management of role permissions to abstract objects in a computing environment comprises a role-based access control system that includes a directed acyclic graph representing role-membership inheritance relationships and a directed acyclic graph representing role-permission inheritance relationships;
association of each role with the set of abstract objects accessible to the said role, said association requiring neither redundant storage and maintenance of permissions nor exhaustive system searches.

23. A program product as defined in claim 22, further comprising code for performing the following method steps:
defining and managing the abstract permissions of a role on abstract objects;
finding, retrieving, and displaying abstract permissions of a role on abstract objects;
adding an abstract object to the set of abstract objects associated with a role whenever said abstract object becomes accessible to said role; and
deleting an abstract object from the set of abstract objects associated with a role whenever said abstract object becomes inaccessible to said role.

24. A program product as defined in claim 23, further comprising code for performing the following method steps:
creating, finding, retrieving, displaying, and deleting instances of a role on a host computer or set of host computers, using group nesting and a directed acyclic graph of role-membership inheritance;
creating finding, retrieving, displaying, and deleting object instances of abstract objects on a host computer or set of host computers;
registering objects as instances of abstract objects on a host computer or set of host computers;
deriving permissions of a role instance on object instances from the abstract permissions of said role on said abstract objects;
registering permissions on objects as instances of abstract permissions on abstract objects on a host computer or set of host computers; and
finding, retrieving, and displaying the permissions derived from abstract permissions defined on abstract objects.

25. A program product as defined in claim 24, further comprising code for performing the following method steps:
creating an instance of a RBAC user on a set of host computers, said user instance being called global with respect to said set of host computers;
creating an instance of a RBAC user on a host computer, said user instance being called local with respect to said host computer, unless said host computer is used to control a set of host computers, in which case the instance is called global with respect to said set of host computers;
creating a role instance on a set of host computers, said role instance being called global with respect to said set of host computers;
creating a role instance on a host computer, said role instance being called local with respect to said host computer, unless said host computer is used to control a set of host computers, in which case one can select whether the instance will be local with respect to said host computer, or global with respect to said set of host computers;
including a local user instance in a local role instance, if said user is assigned to said role, and both said instances were derived on the same host computer;
including a global user instance in a local role instance, if said user is assigned to said role, and said local role instance was derived on a host computer included in the set of host computers used to derive said global user instance;
including the global user instance in a global role instance, if said user is assigned to said role, and both said instances were derived on the same set of host computers;
including the members of a local instance of a first role in a local instance of a second role, if the second role inherits the membership of the first role, and both said instances were derived on the same host computer;
including the global instance of a first role as a member of a local instance of a second role, if the second role inherits the membership of the first role, and said local instance was derived on a host computer included in the set of host computers used to derive said global instance; and
including the members of a global instance of a first role in a global instance of a second role, if the second role inherits the membership of the first role, and both said instances were derived on the same set of host computers.

26. A program product as defined in claim 24, further comprising code for performing the following method steps:
computing, displaying, reviewing, and listing the permissions of any role to abstract objects; and
computing, displaying, reviewing, and listing the permissions of any role to object instances; and
computing, displaying, reviewing, and listing the permissions of any role instance to object instances.

27. A program product as defined in claim 26, further comprising code for performing the following method steps:
determining whether two or more roles share permissions on any abstract objects; and
determining whether two or more roles share permissions on any object instances; and
determining whether two or more role instances share permissions on any object instances; and
implementing and testing any policy that is satisfied by the determination of whether two or more roles share permissions to abstract objects; and
implementing and testing any policy that is satisfied by the determination of whether two or more roles share permissions to object instances; and
implementing and testing any policy that is satisfied by the determination of whether two or more role instances share permissions to object instances.

28. A program product as defined in claim 27, further comprising code for performing the following method steps:
implementing and testing generalized separation-of-duty policies; and
implementing and testing operational separation-of-duty policies.

29. A program product as defined in claim 24, further comprising code for performing the following method steps:
automatic distribution of permissions on object instances to role instances whenever new permission-inheritance relations are established among roles; and
automatic distribution of permissions on object instances to role instances whenever new roles are added to the directed acyclic graph; and
automatic distribution of permissions on object instances to role instances whenever a new role instance is created for a role on a host computer or set of host computers; and
automatic distribution of permissions on object instances to role instances whenever a new object instance is created for an abstract object on a host computer or set of host computers; and
for automatic distribution of permissions on object instances to role instances whenever a new permission is granted to a role.

30. A program product as defined in claim 24, further comprising code for performing the method steps of:
automatic revocation and recalculation of permissions on object instances for role instances whenever permission-inheritance relations among roles are removed; and
automatic revocation and recalculation of permissions on object instances for role instances whenever roles are removed; and
automatic revocation and recalculation of permissions on object instances for roles instances whenever an abstract object is removed; and
automatic revocation and recalculation of permissions on object instances for role instances whenever a permission is revoked from a role.

31. A program product as defined in claim 24, further comprising code for performing the method step of:
scaleable, automatic, distribution, revocation, and recalculation of permissions of role instances to object instances that support efficient access authorization.

32. A program product as defined in claim 31, further comprising code for performing the method steps of:
adding a new permission-inheritance arc to the directed acyclic graph between a first role called inheritor role and a second role called the inherited role whereby the inheritor and all its ascendant roles inherit all the permissions of the inherited role and its descendant roles in the directed acyclic graph; and
automatically selecting the roles that do not have instances on a host computer or set of host computers from the set comprises the said inherited role and its descendants in the directed acyclic graph; and
automatically computing a set of permissions by mapping the abstract permissions of said selected roles on all abstract objects that do have instances on said host computer or set of host computers; and
automatically granting said computed permissions to the instance of each first encountered role instantiated on said host computer or set of host computers by traversing the directed acyclic graph in the direction opposite to that of the inheritance arcs on any path starting from the inheritor role.

33. A program product as defined in claim 32, further comprising code for performing the method steps of:
removing a permission-inheritance arc from the directed acyclic graph between a first role called inheritor role and a second role called the inherited role; and
automatically recalculating permissions and granting said permissions to the instance of each first encountered role instantiated on a host computer or set of host computers, by traversing the directed acyclic graph in the direction opposite to that of the inheritance arcs on any path starting from the inheritor role.

34. A program product as defined in claim 32, further comprising code for performing the method steps of:
revoking an abstract permission to an abstract object from a role where said abstract object has an instance on a host computer or set of host computers; and
automatically updating the association between the said role and the set of accessible abstract objects; and
automatically recalculating permissions and granting said permissions to the instance of each first encountered role instantiated on a host computer or set of host computers, by traversing the directed acyclic graph in the direction opposite to that of the inheritance arcs on any path starting from the said role.

35. A program product as defined in claim 32, further comprising code for performing the method steps of
deleting a role from the directed acyclic graph, further comprising:
selecting a role for deletion from the directed acyclic graph;
automatically removing the said role from the access control lists of all abstract objects accessible to said role; and
automatically deleting the association between said role and all abstract objects accessible to said role; and
automatically recalculating permissions and granting said permissions to the instance of each first encountered role instantiated on a host computer or set of host computers, by traversing the directed acyclic graph in the direction opposite to that of the inheritance arcs on any path starting from the any direct ascendant of the selected; and
automatically deleting all instances of the selected; and
automatically deleting the selected role from the directed acyclic graph.

36. A program product as defined in claim 31, further comprising code for performing the method steps of:
creating an instance of a role on a host computer or set of host computers; and
automatically selecting the roles that did not have instances on said host computer or set of host computers prior to the creation of said role instance, wherein the selection is performed from said role and its descendant roles in the directed acyclic graph; and
automatically computing a set of permissions by mapping the abstract permissions of said selected roles on all abstract objects that do have instances on said host computer or set of host computers; and
automatically granting said computed permissions to said role instance just created.

37. A program product as defined in claim 31, further comprising code for performing the method steps of:
creating an instance of a user on a host computer or set of host computers; and
automatically selecting the roles that did not have instances on said host computer or set of host computers prior to the creation of said user instance, wherein the selection is performed from said user and its descendant roles in the directed acyclic graph; and
automatically computing a set of permissions by mapping the abstract permissions of said selected roles on all abstract objects that do have instances on said host computer or set of host computers; and
automatically granting said computed permissions to said user instance just created.

38. A program product as defined in claim 31, further comprising code for performing the method steps of:
granting a role an abstract permission to an abstract object that has an instance on a host computer or set of host computers and automatically causing the said role's ascendant roles and users to inherit the said abstract permission; and
automatically updating the association between the said role and the set of accessible abstract objects; and
automatically mapping the said abstract permission of said role on said abstract object to a set of permissions for the object instance; and
automatically granting said set of permissions to the instance of each first encountered role instantiated on said host computer or set of host computers by traversing the directed acyclic graph in the direction opposite to that of the inheritance arcs on any path starting from the role being granted the abstract permission.

39. A program product as defined in claim 31, further comprising code for performing the method steps of:
instantiating an abstract object on a host computer or set of host computers; and
automatically reading the access control list of the abstract object and computing the set of roles that have abstract permissions to the said abstract object; and
for each role in the said set, automatically mapping the abstract permissions of said role on said abstract object to a set of permissions for the object instance; and automatically granting said set of permissions to the instance of each first encountered role instantiated on said host computer or set of host computers by traversing the directed acyclic graph in the direction opposite to that of the inheritance arcs on any path starting from said role.

40. A program product as defined in claim 31, further comprising code for performing the method steps of
deleting an abstract object, further comprising code for:
automatically finding and deleting all instances of said abstract object and their access control lists; and
automatically reading the access control list of said abstract object and, for each role found in the said access control list, removing the said abstract object from the association between said role and its set of accessible abstract objects; and
automatically deleting the said abstract object and its access control list.

41. A program product as defined in claim 31, further comprising code for performing the method steps of:
deriving a directed acyclic graph of roles representing both membership and permission inheritance, abstract objects, and abstract permissions, from the user account, group, and access control list and permission structures of extant operating systems; and
performing the incremental transition from an extant permission management system to automatic permission management in RBAC.

42. A program product as defined in claim 31, further comprising code for performing the method steps of:
deriving membership-inheritance and permission-inheritance relationships among the existing user accounts and groups; and
creating roles and assigning selected user accounts and groups to said roles; and
deriving membership-inheritance and permission-inheritance relationships among said roles and obtaining a directed acyclic graph for each type of inheritance relationship; and
transforming the said directed acyclic graphs into a single directed acyclic graph of membership inheritance that preserves the permission of the user accounts defined by permission inheritance.
